(19) United States
(12) Patent Application Publication
(10) Pub. No.: US 2004/0199765 A1
(43) Pub. Date: Oct. 7, 2004

(54) System and method for providing personal control of access to confidential records over a public network

(75) Inventors: Isaac S. Kohane, Brookline, MA (US); Peter Szolovits, Newton, MA (US); Alberto Riva, Boston, MA (US); Kenneth D. Mandl, Brookline, MA (US)

Correspondence Address: TESTA, HURWITZ & THIBEAULT, LLP, HIGH STREET TOWER, 125 HIGH STREET, BOSTON, MA, 02110, US

(73) Assignee: Children's Medical Center Corporation, Boston, MA

(21) Appl. No.: 10/743,518

(22) Filed: Dec. 22, 2003

Related U.S. Application Data
(63) Continuation of application No. 09/410,717, filed on Oct. 1, 1999, now abandoned.
(60) Provisional application No. 60/150,154, filed on Aug. 20, 1999.

(51) Int. Cl. H04L 9/00

(52) U.S. Cl. 713/165

(57) ABSTRACT

Described are a system and method for maintaining confidential records of an individual over a publicly accessible network. The system and method provide adequate confidentiality of the confidential records, mobility of individual access to the records, security of the data in the records, individual control of the confidential records, and integration with institutional information systems. The individual selects a publicly accessible record server for storing a confidential record. The confidential record is encrypted and stored by the gateway system on the selected record server. A predetermined agent is given an access token for accessing the confidential record over the network through the gateway server system. In a medical context, for example, the predetermined agent can be a health care institution, a medical research facility, or the individual who is a patient. The individual determines the privileges for the predetermined agent for accessing the confidential records. Such privileges can include reading, creating, modifying, annotating, and deleting. The individual also determines each portion of the confidential record that is accessible to the predetermined agent.

### RELATED APPLICATION

This application claims the benefit of U.S. Provisional Application, Serial No. 60/150,154, filed Aug. 20, 1999, incorporated by reference herein.

### FIELD OF THE INVENTION

The invention relates generally to accessing data over a public network. More specifically, the invention relates to a system and method for controlling access to data records on the Internet.

### BACKGROUND OF THE INVENTION

Current health information systems often yield fragmented and inaccessible patient records. Such fragmentation is compounded when patients frequently change their affiliations with health care providers. Consequently, the medical record system of each health care provider typically maintains a mere fraction of the medical history of a patient. Further, the competitive nature of health care delivery provides little incentive for health care providers to support broad sharing of patient records. Hence, in an age of increased deployment of electronic medical records, the patient still has little access to their own complete record. Moreover, such patients typically have little or no control of their own records.

Several records systems have arisen that attempt to take advantage of the Internet to remedy these inadequacies. Generally, such systems make patients' medical records available over the Internet, permitting the patients to visit their records from remote sites. However, none of such record systems provide adequate confidentiality of the patient data, portability, security of the data, integration with institutional health information systems, and patient control of the medical record. Therefore, there remains a need for a medical record system that avoids the aforementioned problems.

### SUMMARY OF THE INVENTION

The present invention features a system and method for maintaining confidential records of an individual on a network. Objectives of the invention are to maintain adequate confidentiality of the confidential records, mobility of the individual for accessing the records, security of the confidential records, control of the confidential records by the individual, and integration with institutional information systems. Examples of confidential records are medical records and financial records. Other types of confidential records are within the scope of the invention.

In one aspect, the invention relates to a method in which an individual selects a publicly accessible record server for storing a confidential record of the individual. The confidential record is encrypted, transmitted to a predetermined gateway system, and stored by the gateway system on the selected record server. The gateway server system and the record server can be the same node on the network.

In one embodiment, the individual gives a predetermined agent an access token for accessing the confidential record over the network. For example, the predetermined agent can be, within a medical context, a health care institution, a medical research facility, or the individual as a patient. Access tokens for accessing the confidential record include a private cryptographic key, a biometric of the predetermined agent (e.g., fingerprint), and a smart card.

The individual controls the privileges that the predetermined agent has for accessing the confidential record of the individual. In one embodiment, the individual associates a class of agents with a set of privileges for accessing the confidential record. Classes of agents include the record owner, an individual agent, an agent group, and an “other” category. When the class is an agent group, all members belonging to that group can exercise the set of privileges given to the group.

The predetermined agent can be associated with at least one class. The individual or an institution can associate the predetermined agent with a particular class. For example, when the particular class is an agent group representing all members of an institution, e.g., the doctors of a particular clinic, the institution determines the membership of the agent group. To associate the predetermined agent with the privileges of the particular class, the institution makes the predetermined agent a member of the agent group.

Such privileges can include reading, creating, modifying, annotating, and deleting. The predetermined agent can access the encrypted confidential record on the record server from any node on the network capable of accepting the access token.

In another embodiment, the anonymity of the individual is maintained when the predetermined agent accesses the encrypted confidential record of the individual. For example, the predetermined agent can be a research institution needing patient data for a study. In this case, the patient data can be provided without any indicia of patient identity.

In still another embodiment, the individual determines each portion of the confidential record that is accessible to the predetermined agent.

In another aspect, the invention features a system for providing access to confidential records of an individual over a network. The system includes digital information representing a confidential record of the individual. A publicly accessible server system is connected to the network and is selected by the individual for storing the confidential record. A gateway system in communication with the server system comprises software for accessing the confidential record of the individual.

Each confidential record includes record objects. Each record object includes a privilege section that associates classes of agents with privileges for accessing that record object. The individual associates the predetermined agent with one of the classes of agents.

### BRIEF DESCRIPTION OF THE DRAWINGS

The invention is pointed out with particularity in the appended claims. The advantages of the invention described above, as well as further advantages of the invention, may be better understood by reference to the following description taken in conjunction with the accompanying drawings, in which:

FIG. 1 is a block diagram of a record system according to the principles of the invention, including agents in communication with servers through a gateway server system;

FIG. 2A is a block diagram illustrating a table on the gateway server system for mapping each record owner to the location of a directory file for the respective record of that record owner stored on one of the servers;

FIG. 2B is a block diagram illustrating a table on the gateway server system for authenticating agents for access to records on the servers;

FIG. 3 is a block diagram illustrating an exemplary Document Type Definition (DTD) for an embodiment of the EXtensible Markup Language (XML) directory file format used to represent records;

FIG. 4 is a block diagram illustrating an exemplary XML file formatted according to the DTD shown in FIG. 32;

FIG. 5 is a flow diagram illustrating an exemplary process by which an agent using an agent system accesses a record stored on one or more servers through the gateway server system; and

FIGS. 6A and 6B are block diagrams of exemplary XML files illustrating an exemplary process by which a record Owner can modify access privileges to one or more objects in a record.

### DETAILED DESCRIPTION OF THE DRAWINGS

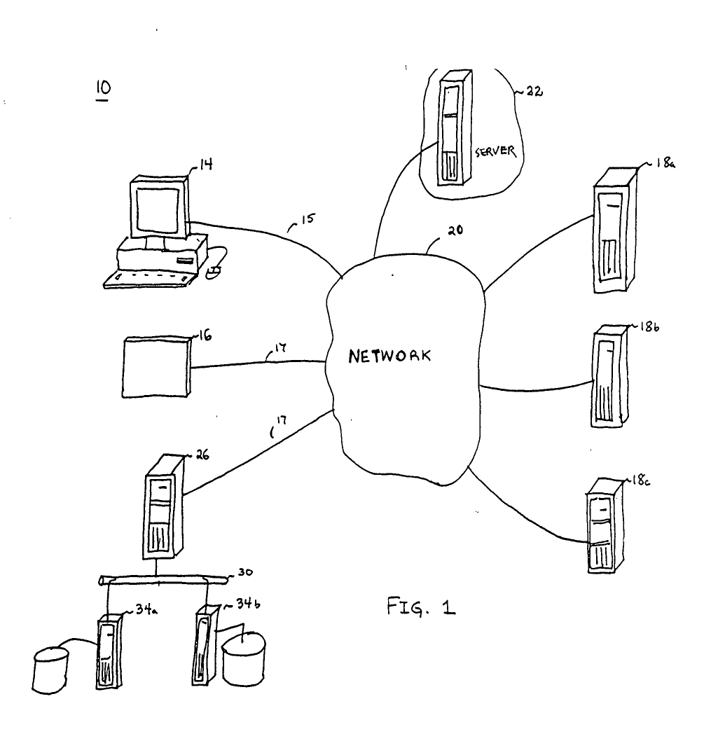

FIG. 1 shows a record system 10 including client systems 14, 16, 26 (hereafter agent systems) in communication with servers 18a, 18b, 18c (collectively, server 18) through a gateway server system 22 over a network 20. This network 20 can be a large international network (e.g., the Internet, the World Wide Web, or Wide Area Network (WAN)) or a small local area network (LAN).

According to the principles of the invention, the record system 10 enables anyone who uses one of the agent systems 14, 16, 26 to access a record concerning a particular individual or entity over the network 20. Hereafter, such individual (or entity) is referred to as the record owner, and any individual who uses one of the agent systems 14, 16, 26 to access the record of the record owner is referred to as an agent. The agent can be the record owner, a member of an institution (e.g., health care institution), university, research facility, financial institution, legal profession, the general public, or, government employee, etc. In addition, agents can be members of a group. For example, an agent group can be all members of an institution (e.g., the doctors of a particular clinic).

An agent system 14, 16, 26 is any system capable of communicating with the gateway server system 22. The agent system 14, 16, 26 can be a software program executing on a computer system (e.g., a laboratory information system that produces messages), or a hardware device.

The agent system 14 is an exemplary embodiment of an agent system by which an agent can access records stored on the servers 18 according to the principles of the invention. The agent system 14 is any conventional personal computer, workstation, or network terminal and may include a processor, memory for storing data and software programs, a display screen, a keyboard, and a mouse. The agent system 14 can include a device (e.g., a smart card reader, a fingerprint reader, etc.) to accept a token that authenticates the identity of the agent using the agent system 14.

The agent system 14 can also include a modem for communicating with the gateway server system 22 over the network 20 over a communication link 15. The communication link 15 can be any one of a variety of connections including standard telephone lines, LAN or WAN links (e.g., T1, T3, 56 kb, X.25), broadband connections (ISDN, Frame Relay, ATM), and wireless connections.

Installed on the agent system 14 is client software that presents a user interface to the agent using the agent system 14 and communicates with the gateway server system 22 using the Hypertext Transport Protocol (HTTP). When executed, the client software can download a Web page across the communication link 15 from the gateway server system 22. The client software translates the downloaded text files with any accompanying graphics files and applets and displays the results on the display screen. An example of the client software is browser software, such as, Netscape Navigator™ or Microsoft Internet Explorer™.

Similarly, the agent system 16 is another embodiment of an agent system by which an agent can communicate with the gateway server system 22 over a communications link 17 to process information for that agent. Generally, the agent system 16 is an instrument, machine, equipment, or hardware device capable of taking measurements and transmitting the measured information to the gateway server system 22.

In the context of a medical record system, one embodiment of the agent system 16 is a medical instrument that measures a physical characteristic of an individual (e.g., a patient). The agent system 16 can place the measured information into a format that enables that information to be included in a record for the patient. In another embodiment, the agent system 16 is a smart-card based system that permits the creation of personal electronic records.

Again, the communication link 17 over which the agent system 16 communicates with the gateway server system 22 can be any one of a variety of connections including standard telephone lines, LAN or WAN links (e.g., T1, T3, 56 kb, X.25), broadband connections (ISDN, Frame Relay, ATM), and wireless connections.

The agent system 26 is still another embodiment of an agent system that can communicate with the gateway server system 22 to process information. In one embodiment, the agent system 26 is a computer system that is in communication with one or more legacy data systems 34a and 34b (collectively 34) over a network 30. For example, the legacy data systems 34 can be databases containing confidential records maintained by independent institutions such as hospitals, financial, and legal institutions.

In brief overview, the agent system 26 receives information pertaining to an individual (e.g., a medical patient) from one or more of the data systems 34. The agent system 26 then converts the information into a proper format so that the gateway server system 22 can integrate that information into an existing record of that individual in accordance with the principles of the invention. One method for formatting information from legacy databases is the World Wide Web—Electronic Medical Record System (W3 ERMS) described by Kohane et al. in “Building National Electronic Medical Record Systems via the World Wide Web,” published by the Journal of the American Medical Association 1996; 3(3):197-207. Other publications describing W3 ERMS include Wingerde et al, “Using HL7 and the World Wide Web for Unifying Patient Data from Remote Databases,” and Kohane et al, “Sharing Electronic Medical Records Across Multiple Heterogeneous and Competing Institutions,” both published in Proceedings, Annual Fall Symposium of the American Medical Informatics Association; 1996 Washington, DC: Hanley & Belfus, Inc., 1996, pp. 643-7 and pp. 608-12, respectively.

Each server system 18 is a conventional computer system capable of operating as a Web site, communicating according to the Hypertext Transfer Protocol (HTTP) protocol, processing Universal Resource Locators (URLs), and maintaining Web pages in memory. Such capabilities include receiving requests to access the stored Web pages and for transmitting the information related to an accessed Web page to the requesting computer system. Each server system 18 can also receive files over the network 20 and store such files in local or remote storage. One or more Internet Service Providers (ISPs) or business associations can maintain and operate the server systems 18, independently or jointly.

An advantage of the invention is that agents can access records on the Web servers 18, upon presenting the proper credentials, from any agent system connected to the network 20. For example, a patient can access his or her medical record or an investor can access his or her financial record through a computer system at the place of business, at home, from out of town, or in transit over a wireless link. Consequently, the invention permits agents to be mobile without affecting the ability of the agents to reach the records.

A Record

A record is an integrated collection of information concerning a particular individual or entity. That particular individual (or entity) is the record owner. The creator of the record, hereafter called the record author, can be the record owner or another agent. For example, the record can be a medical record pertaining to a particular patient (the record owner) produced by a health care institution (the record author). In other embodiments, the record can include other types of personal or confidential information, such as financial data, legal data, etc. The record can include a mixture of information types, such as a medical history combined with legal information.

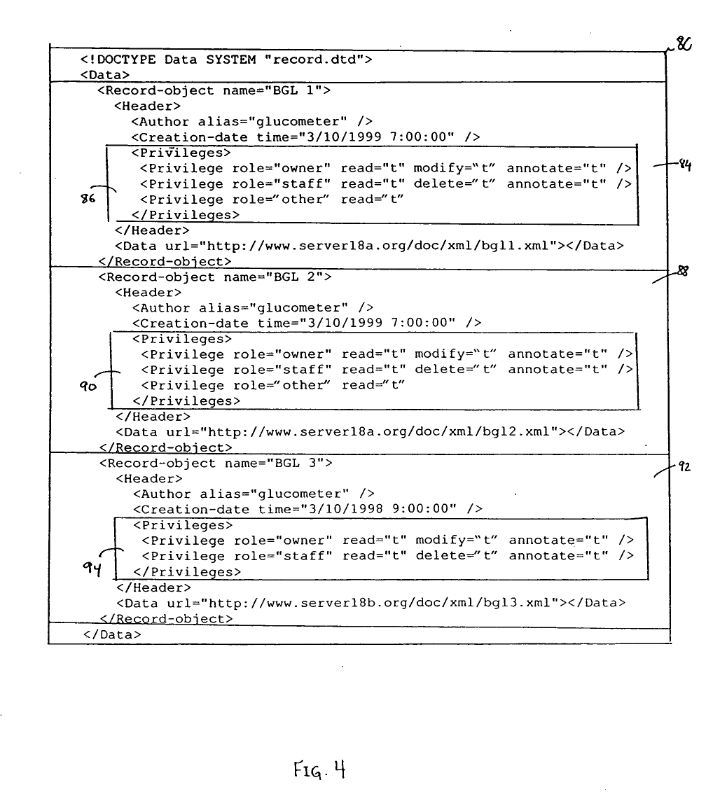

In one embodiment, the complete record is represented using an XML directory tree. XML is a document format for the Web that permits a Web page developer to define tags that describe elements within the Web page. A Document Type Definition (DTD) provides the definition of these tags and establishes the grammar of the mark-up language. The DTD is described below in more detail in connection with FIG. 3. Although XML is an excellent document format for this application, other document formats can be used.

When the record owner initially connects to the gateway server system 22 (using the agent system 14, 18, or 26), the record owner can control the server 18 upon which the record is stored as an XML directory file. The record owner specifies the server and root directory on that server within which the gateway server system 22 can store the directory file. Accordingly, the record owner is giving the gateway server system 22 privileges to write to that root directory on the specified server. The gateway server system 22 generates the sub-directory or sub-directories within the root directory for storing the directory file. The record owner may, but does not need to know, the sub-directory used by the gateway server system 22. The XML directory file can be distributed across multiple Web pages and multiple servers 18. Also, the XML directory file can reference any Multi-purpose Internet Mail Extension (MIME) data type (e.g., text, sound, and video).

In one embodiment, the information about the record owner in the record is embodied in record objects. Record objects are a logical unit of information maintained by the system 10. Similarly, the creator of the record object, hereafter called the record object author, can be the record owner or another agent.

Record objects, like the directory file representing the record, are stored on the servers 18. Each record object is individually addressable through a unique URL. Also, each record object can include other record objects. Each server 18 can hold all or a portion of the record objects corresponding to the record of the record owner. For example, the complete record can reside on server 18a.

As another example, the record can include three record objects, with one object record residing on server 18a, a second record object residing on server 18b, and a third record object residing on server 18c. The record object on server 18a can include a dental history (e.g., dental X-rays) of the record owner, the record object on server 18b can include health information of that record owner, and the record object on server 18c can include financial information of that record owner. According to the principles of the invention, these three sources of information can combine to produce the record of the record owner. Here, the use of three information sources is merely illustrative, as the invention is not limited in the extent to which the record objects may be distributed across servers 18.

In one embodiment, the record objects of the record are stored on the servers 18 as one or more XML files. The server locations for storing the record objects are also within the discretion of the record owner. As was the case for storing the record, the record owner determines the server and root directory and the gateway server system 22 generates the subdirectories that store the record objects. The record objects possess an internal structure, determined by the DTD, which is known to the gateway server system 22. Within each XML file, each record object maintains a list of access rights that determines the privileges of those attempting to access the information stored within that record object.

Record Access

Access to the record of a particular record owner is through the gateway server system 22. The gateway server system 22 can be a group of server systems acting logically as a single server. An ISP or a business association can maintain and operate the gateway server system 22 as a secured server.

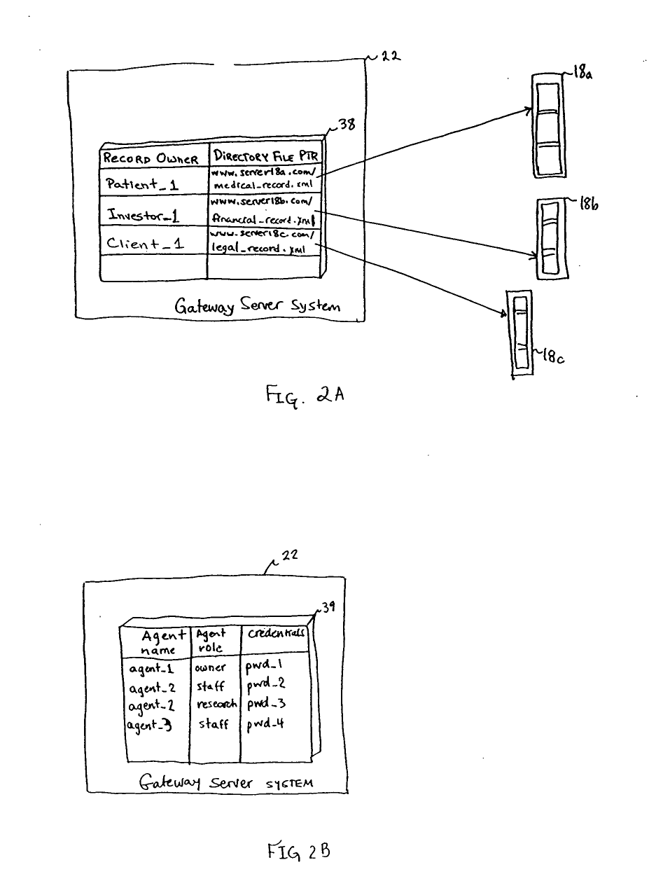

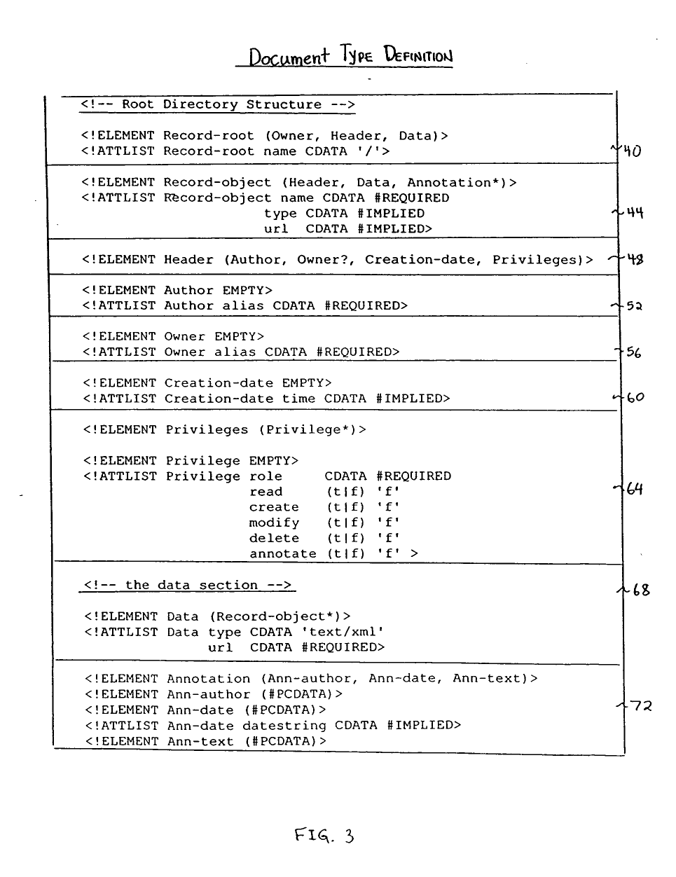

Referring to FIG. 2A, the gateway server system 22 includes a table 38 that maps each record owner to the storage location on one of the servers 18 of the directory file for the respective record of that record owner. For example, the directory file corresponding to the record of the record owner “Patient 1” is located on the server 18a as indicated by the directory file pointer

“www.server18a.com/medical_record.xml”.

Similarly, the directory file corresponding to the record of the record owner “Investor_1” is on server 18b, and for the record owner “Client_1,” is on server 18c.

Agents have roles, and the record owner can grant access rights to agents according to their roles. A role is a class of agents who share a set of privileges over a particular record object. Roles include the record owner (i.e., the agent to whom the record belongs), author (the agent that created the particular record object), individual agent, and groups of agents. The role described as “other” represents those agents that do not have a particular role. The class of “other” can be used, for example, to specify the privileges of the public or a research organization collecting data.

The record owner may assign a role to a particular agent. In other embodiments, an institution determines the individual membership of a particular agent group. For example, when the agent group represents members of a health care institution, that institution determines which agents (e.g., doctors) are members of the agent group.

The gateway server system 22 maintains a table 39 that stores a list of unique identifiers corresponding to known agents and agent groups, and credential information required for each agent and agent group to obtain authentication. An agent can have more than one role, each role requiring credentials for authentication. In another embodiment, the gateway server system 22 can use a Lightweight Directory Access Protocol directory (LDAP), which is a standard for storing electronic directories of individuals, to associate identifiers of agents with public-key certificates.

Record Owner-Controlled Access

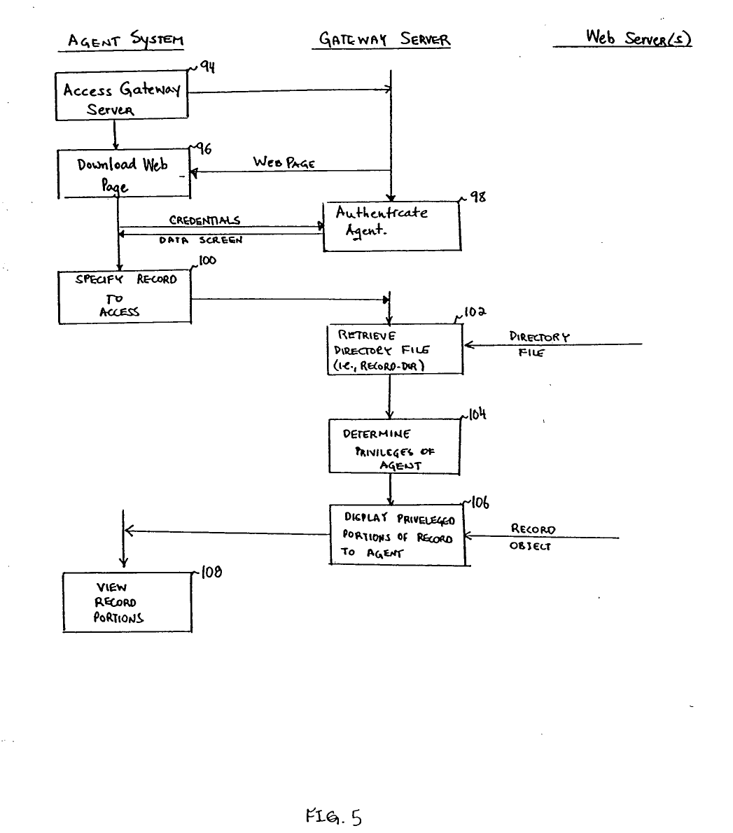

Agents using the various agent systems 14, 16, 26 can access the record of the record owner if the record owner authorizes that agent. The record owner can authorize an agent to access all or only portions of the record. Access-privileges apply to each record object as a whole. The gateway server system 22 uses the information within each record object to determine the access privileges and the data content for that record object as described further below in connection with FIG. 4.

For example, using the previously described exemplary three-part record, the dental portion, medical portion, and legal portion are each distinct record objects in the record. Thus, the record owner can restrict access to the dental object to a particular dentist only, the medical object to a particular health institution only, a record object within the medical object to a medical research facility, and the legal object to a lawyer. The record owner can retain complete access to every record object while completely prohibiting access to any record object to the public.

The record owner can also determine the type of access rights that an agent has for accessing the record. If so permitted by the record owner, the agent can perform a variety of operations upon the record. Such operations include adding a record object to the record (create), removing a record object from the record (delete), retrieving data stored in a record object (read), modifying the information of a record object (modify), and adding an annotation to a record object (annotate). Annotating differs from modifying in that annotating adds information to a record without modifying the information currently in that record, whereas modifying changes information currently in the record. Many environments, (e.g., medical settings), consider the ability to annotate an indispensable function for handling records. For example, the record owner can restrict the access rights of the medical research facility in the above example to read only while allowing the health institution to read and annotate. Such access rights are limited to those record objects for which the record owner has authorized the agent.

Data Confidentiality and Security

In general, the confidentiality of the information stored in the records is of utmost importance. Accordingly, record objects are in encrypted form while stored on the servers 18. Anyone accessing the record objects while stored at the servers 18, other than through the gateway server system 22, are unable to understand the content of the record objects without the appropriate decryption key.

The gateway server system 22 stores the record objects on the servers 18. Before transmitting the record objects to the servers 18, the gateway server system 22 encrypts the record objects. Thus, such record objects traverse the network 20 in encrypted form when the gateway server system 22 uploads the record objects to the server 18. The servers 18 store the record objects in this encrypted form. In addition, the record objects traverse the network 20 in this encrypted form when subsequently downloaded by the gateway server system 22. Consequently, the information in the record objects remain unintelligible to anyone who intercepts the transmission of the record objects between the gateway server system 22 and the server 18 and does not possess the appropriate decryption key.

On the gateway server system 22, each record objects remains in encrypted form except for those record objects that the authorized agent is privileged to access. Accordingly, not every record object may be decrypted, only those record objects for which the accessing agent retains a privilege. The gateway server system 22 possesses and uses the appropriate key to decrypt the record objects obtained from the servers 18. The gateway server system 22 decrypts those record objects for subsequent transmission to the accessing agent.

Before sending the record objects over the communication links (e.g., 15) to the agent system 14, the gateway server system 22 encrypts such record objects. A commercially available security protocol that the gateway server system 22 can use to encrypt the record objects is SSL (Secure Sockets Layer). During a typical SSL session, the Web browser of the agent system 14 sends its public key to the gateway server system 22 so that the gateway server system 22 can securely return a secret key to the browser. The Web browser and gateway server system 22 then communicate using encryption with the secret key during that SSL session. This same security protocol can operate between the gateway server system 22 and the servers 18.

To further assure that sensitive data remains secure, agents cannot access records without presenting the proper credentials for authentication. In one embodiment, each agent is given an access token for accessing records over the network 20. Examples of access tokens include a private cryptographic key, a password, a biometric of the predetermined individual (e.g., fingerprint), and a smart card. The agent can access the record on the server 18 from any agent system capable of accepting the access token. Biometric hardware devices, (e.g., fingerprint readers, face recognition systems, voice spectrum analyzers, etc.), smart-card devices, and hardware key devices can combine with the agent systems to implement the authentication mechanisms.

For further security, the gateway server system 22 can reside behind a firewall of a trusted entity, and thus be accessible through a designated secure port. Also, all non-HTTP communication server software can be removed from the gateway server system 22. Other embodiments can establish data feeds from institutions on predetermined I/O addresses and from machines issued certificates recognized by the gateway server system 22.

Data security can be enhanced at the agent systems 14, 16, 26 by not storing any record objects at the agent systems 14, 16, 26. Accordingly, after the agent completes reviewing the record object, the agent system 14, 16, 26 deletes the corresponding information from the respective agent system, including all downloaded files and cached copies of the downloaded Web page. To secure information transmitted by the agent systems 14, 16, 26 to the gateway server system 22, such information is transmitted over the network 20 in encrypted form, for example, by using SSL.

FIG. 3 shows an exemplary Document Type Definition (DTD) for an embodiment of the XML file format used to represent records. The file format includes a nested hierarchy of elements within a single root. This DTD is stored on the gateway server system 22 in a file (here identified as, e.g., record.dtd) and used to check the syntax of XML files downloaded from the servers 18. The file name of the DTD can be a URL that determines the location of the DTD. In one embodiment, the DTD embodies the HL7 (Health Level 7) standard data model designed to standardize electronic interchange of data (clinical, financial, administrative) among independent health care institutions, such as hospitals, pharmacies, clinical laboratories, etc.

In the embodiment shown, the DTD declares a Record-root element 40, with the Record-Root being the root of the directory structure for the record of the record owner. The Record-root 40 is defined as a group of sub-elements or subgroups including an Owner, corresponding to the record owner, a Header, and a Data section. The DTD also declares a Record-object 44 to be an element that includes a Header 48, Data 68, and zero or more Annotations 72. The Record-object 44 includes three attributes: name, type, and URL. The type attribute indicates the semantics of the Record-object 44.

Definitions for the Header 48, Author 52, Owner 56, Creation Date 60, Privileges 64, and Data 68 sections follow the Record-object 44. The Header section 48 specifies bookkeeping information such as, for example, the author of the Record-object, the date of creation of the Record-object, the type of Record-object, and the privileges for accessing the Record-object. The above described bookkeeping information is exemplary; the Header section 48 can further include other types of information as needed.

The Data section 68 can contain zero or more record objects, denoted by “(Record-object*)” and includes two attributes, “type” and “URL.” In one embodiment, the data section 68 either includes the record data internally or references an external location from which the data can be obtained. When included in the data section 68, the record data are represented within one or more Record-objects.

If a particular record has a data section 68 without any specified Record-objects, the URL attribute can point to a document that has the record data, and the type attribute indicates the syntax of the data within that document. The type attribute indicates the syntax by identifying a particular MIME-type that is associated with the document. In general, MIME-types are keywords separated by ‘/’, where the first keyword describes the broad class of file (e.g., image, text, and audio) and the second keyword describes a particular encoding used (e.g., gif, jpg, and wav).

When the type attribute does not specify a MIME type, the pointed-to document is another XML file that includes the data section of a record object. This is the default case. Alternatively, the type attribute can specify a standard MIME type that indicates that the data are in an XML format. One embodiment uses the HL7 standard for representing the data in that XML file.

When the pointed-to document is another directory file, the type attribute indicates a non-standard MIME type (e.g., type=x-record/dir). This non-standard MIME type is pre-defined to indicate that the pointed-to document is an XML directory file having a format according to the DTD described in FIG. 3.

When the pointed-to document is a binary file, the type attribute specifies the standard MIME type (e.g., type=‘image/gif’), corresponding to the type of data in the document.

In another embodiment, the data section 68 can include both the Record-objects and references to external data locations as described above.

FIG. 4 shows an example of an exemplary XML file 80, e.g., called bgldir.xml, formatted according to the DTD described in FIG. 3. The file 80 is a data section of a directory containing three Record-objects 84, 88, 92. Each Record-object 84, 88, 92 represents a portion of a confidential medical record of the record owner. For example, Record-objects 84, 88, 92 are three different blood glucose measurements received from a glucometer (e.g., agent system 16). Within the header section of each Record-object 84, 88, 92, the glucometer is identified at the author of that Record-object.

The actual data in each Record-object 84, 88, 92 are stored in three different XML files (e.g., here identified as bg11.xml, bg12.xml, and bg13.xml) on the servers 18. These data sections are exemplary. Rather than point to three XML files, the data sections within the Record-objects 84, 88, 92 can include other Record-objects, directory files, or MIME files. For illustration purposes only, the data for two of the Record-objects 84 and 88 are stored on one server, (e.g., 18a, here identified as www.server18a.org), and the data for the other Record-object 92 are stored on another server (e.g., here identified as www.server18b.org).

The exemplary file 80 of FIG. 4 demonstrates that each Record-object 84, 88, 92 has separate access control as defined by the record owner. The record owner achieves the separate access control by customizing the privileges within the header section of the corresponding record objects to reflect the desired accessibility.

For example, the privilege sections 86, 90 of Record-objects 84 and 88, respectively, give read, modify and annotate privileges to the record owner, read, delete, and annotate privileges to the group called “staff,” and read privileges to the group called “other.” The privilege section 94 for Record-object 92 gives the same privileges to the record owner and the group called “staff” as given in Record-objects 84 and 88, but gives no privileges to the group called “other.” In one embodiment, the record owner grants privileges by setting the corresponding access right to TRUE (“t”). The default setting is FALSE—no granted privilege. Here, omitting the role “other” from within the privilege section effectively denies all privileges to the group “other.” By the above exemplary privilege settings, the record owner controls access to the data created on Mar. 10, 1999 separately from the access to the data created on Mar. 10, 1998.

Accessing the Record System

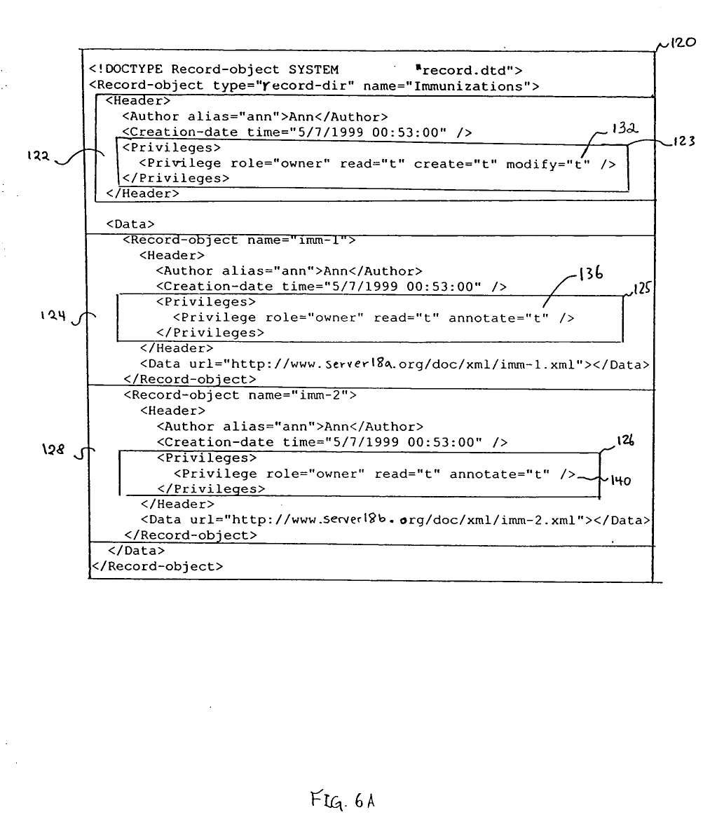

FIG. 5 shows the general operation of the record system 10. During operation, the agent system 14 executes (step 94) the Web browser to download a Web page from the gateway server system 22. In another embodiment, the agent can execute client software installed on the agent system 14 that connects to the gateway server system 22. The agent system 14 downloads (step 96) the Web page from the gateway server system 22 and displays the Web page to the agent on the display screen. In one embodiment, the downloaded Web page is written in a markup language (e.g., HTML, XML, SGML, etc.) and the agent system 14 and the gateway server system 22 communicate using the HTTP protocol.

The downloaded Web page displays log-in fields requiring the agent to provide valid credentials, such as agent name and password, before permitting access to any records on the record system 10. When the agent provides valid credentials, the gateway server system 22 authenticates (step 98) the connecting agent. Referring to FIG. 2B, the gateway server system 22 references the table 39 of authorized agents and corresponding credentials for validating each agent. To authenticate the connecting agent, the gateway server system 22 searches the table 39 for the name of the agent. Upon finding a table entry with the agent name, the gateway server system 22 compares the credentials supplied by the agent with the credentials listed in the table entry. Because an agent can have more than one role, the table 39 can have more than one entry for that agent. The gateway server system 22 examines each found entry. A match authenticates the agent.

Accessing Records

Referring again to FIG. 5, upon validating the agent the gateway server system 22 presents a data entry screen to the agent for receiving input from the agent. Through the data entry screen, the agent specifies (step 100) the record to be accessed (e.g., by supplying identification of the record owner). The gateway server system 22 accesses the table 38 of FIG. 2A that maps each record owner to an XML directory file on the servers 18. The gateway server system 22 obtains a pointer to the directory file associated with the specified record owner and retrieves (step 102) the file from the server 18 where the directory file is stored.

Accessing Record Objects

Agents specify the desired record operation (e.g., read, modify, etc.) using data entry screens, editing, and annotating facilities provided by the gateway server system 22. The gateway server system 22 parses (step 104) through the directory file to determine those record objects that the accessing agent can manipulate according to the specified record operation. For the accessing agent to have access to the record objects within the file, the privilege section within the header of the directory file needs to grant that agent with at least the privilege to read. If the accessing agent has the privilege to read the record, the gateway server system 22 then determines whether the agent can access each record object in the data section of the directory file on a record object by record object basis.

In one embodiment, to determine whether the accessing agent can perform the desired operation on a given record object, the gateway server system 22 determines the set of roles whose privileges include that operation. If “other” is a member of this set of roles, then the accessing agent is authorized to perform the desired operation on this record object, and the process terminates. If “owner” is a member of this set of roles, then the “owner” role is replaced by the identity of the record owner. If “author” is a member of set of roles, then the identity of the agent that created the object replaces this “author” role. The gateway server system 22 then determines the intersection between the set of roles, including the identities of owner and/or the author, and the identities supplied by the agent. If the intersection is empty, the request is denied and the process terminates.

When the intersection is not empty, the gateway server system 22 determines whether the agent can prove that ownership of at least one of the identities in the resulting intersection. The gateway server system 22 and the agent system 14 can negotiate to determine the form of authentication to use. The gateway server system 22 can refuse to authenticate using a scheme deemed to be too weak, despite receiving proper credentials from the agent.

After the agent provides valid credentials for one of the desired identities, the request is granted and the process terminates. If all identities fail, then the request is denied.

Modify a Record

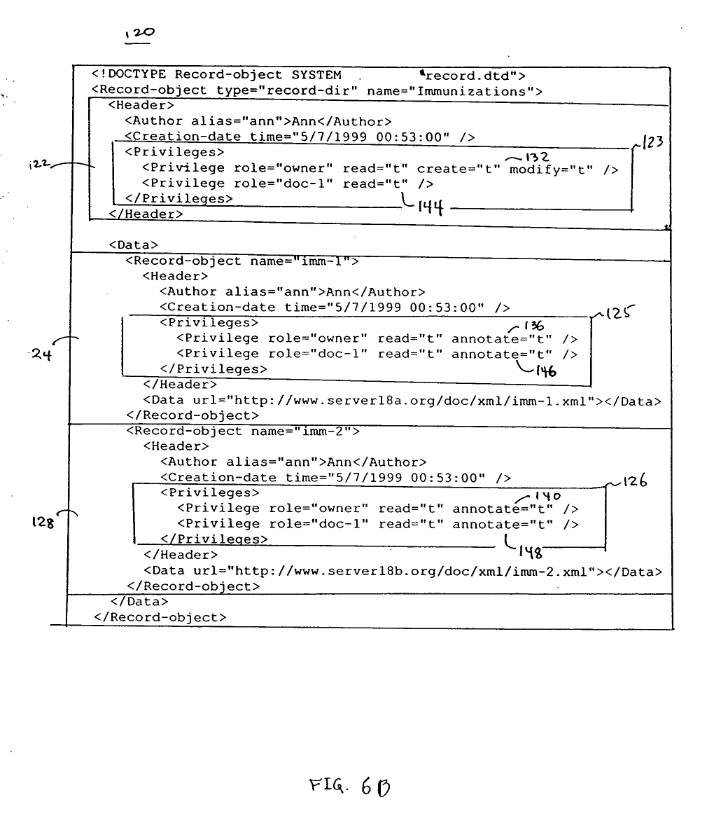

FIGS. 6A and 6B show an exemplary process by which a record owner can modify the access privileges to one or more record objects. FIG. 6A shows an exemplary document 120 describing a directory entitled “Immunizations.”

The directory includes two record objects 124, 128, here identified as “imm-1” and “imm-2.” These exemplary record objects 124, 128 can contain immunization data. The actual immunization data are stored in the files “imm-1.xml” and “imm-2.xml” located on the servers www.server18a.org and www.server18b.org, respectively. These data files and storage locations are exemplary.

The privilege section 132 grants the record owner the privileges to list (i.e., read) the contents of the Immunization directory, to add new entries (i.e., create) to the directory, and to modify the directory (i.e., modify). The privilege sections 136 and 140 give the record owner the privileges to read and annotate each record object 124 and 128, respectively. According to the privilege sections 132, 136, 140, no other agents or agent groups can read, create, modify, delete or annotate the directory or the record objects.

FIG. 6B shows the exemplary document 120, entitled “Immunizations,” after the record owner grants read and annotation privileges to another agent, here a doctor identified as “doc_{—1,” for each record object 124, 128. The record owner adds an entry 144 corresponding to the doctor, doc}_{—1, within the privilege section 123 of the header section 122. This entry 144 grants the doctor, doc}_{—1, a privilege to read the directory. In addition, an entry 146, 148 is added to each of the privilege sections 125, 126 of the record objects 124 and 128, respectively, granting the doctor, doc}_{—1, the privileges to read and to annotate each record object 124, 128.}

When modifying privileges, certain rules generally apply. Only the record owner can modify privileges. To modify the privileges, the record owner should have the “modify” privilege over the directory. The record owner cannot grant privileges to other agents that the record owner does not possess. For example, the record owner cannot give another agent the privilege to delete a record object if the record owner does not have the privilege to delete that record object.

The record owner cannot modify his/her own privileges for a given record object. The gateway server system 22 establishes the initial privileges for that record object. For establishing these initial privileges, the gateway server system 22 maintains a database that associates initial privileges with record object types. The database specifies the initial privileges of the record owner for each type of record object and those who can create such record objects. The type of initial privileges depends upon the type of record object. For example, a health institution can have initial privilege to create a record object that includes immunization data, while the record owner may not have that very privilege. While the record owner cannot give himself/herself that privilege, the record owner can take the privilege away from the health institution.

Accordingly, the gateway server system 22 verifies that the agent attempting to grant or remove a privilege is the record owner and that the record owner possesses the privilege that the record owner is attempting to modify. This verification can be the same verification process used by the gateway server system 22 when ascertaining whether the record owner (or other agent) has certain privileges to perform an operation requested by that agent.

Modifying Record Objects

Modification of record objects can occur in at least two modes: with and without a user interface. To enable modification of record objects through a user interface, the gateway server system 22 presents the record objects to an authorized agent using a data entry screen. Through the data entry screen, the authorized agent can edit and annotate the data in the appropriate fields of the data entry screen. Modifying record objects without a user interface occurs when an agent system (e.g., 18 and 26) communicates with the gateway server system 22 according to a protocol capable of creating object records.

Under the control of the gateway server system 22, data modifications and annotations return to the server 18 from which the modified record object was obtained.

Adding Record Objects

An agent, if granted the appropriate privilege, can also add record objects to an existing record through a data entry screen provided by the gateway server system 22. The agent specifies the storage location of the new record object (e.g., the URL or address of the server, pathname, and filename), those agents that can access each new record object, and the access rights of those agents. The gateway server system 22 makes the appropriate changes to the directory file to insert the record object within the data section. If the modifying agent is one other than the record owner, the record owner must grant that agent the privilege to create the record object, and the directory file must reflect the grant of that privilege to the agent. Then the directory file of the record owner can be modified to include the new record object.

Record-objects produced by agents other than the record owner are examples of record objects that have an author that differs from the record owner. For example, the agent system 26 can be operated by a health institution which authors record objects pertaining to a patient, who is the record owner of those authored record objects.

Anonymization

Under certain circumstances, the record owner may desire that portions of the record of the owner be made accessible to other agents without revealing the identity of the owner. For example, a research institution may need patient data for a study. According to the principles of the invention, the record owner can ensure that the medical research facility can access only anonymous data by making the patient data available without any indicia of record owner identity.

For example, the record owner can place personal identification information within one record object, and the medical information within another record object. Then the record owner can give agents falling within the “other” role a privilege to read the record object having the medical information, but grant no privileges to the record object with the personal identification information. Consequently, when the research institution accesses the record of the record owner, the gateway server system 22 parses through the associated directory file and skips over those record objects for which the research institution is unauthorized.

The present invention may be provided as one or more computer-readable programs embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, LISP, PERL, C, C++, PROLOG, or any byte code language such as JAVA. The software programs may be stored on or in one or more articles of manufacture as object code.

Having described certain embodiments of the invention, it will now become apparent to one of skill in the art that other embodiments incorporating the concepts of the invention may be used. Therefore, the invention should not be limited to certain embodiments, but rather should be limited only by the spirit and scope of the following claims.

1. A method for maintaining confidential records of an individual comprising the steps of:
selecting, by the individual, a record server that is publicly accessible over a network; encrypting a confidential record of the individual;
storing the encrypted confidential record on the selected record server; and
accessing the encrypted confidential record stored on the selected record server through a defined gateway system.

2. The method of claim 1 further comprising the step of distributing an access token to a predetermined agent by the individual for use in accessing the stored confidential record over the network.

3. The method of claim 2 wherein the predetermined agent is a healthcare institution.

4. The method of claim 1 wherein the confidential record is a medical record.

5. The method of claim 4 wherein the individual is a patient.

6. The method of claim 5 wherein the predetermined agent is the patient who has privileges to read, modify, and annotate the medical record.

7. The method of claim 2 further comprising the step of controlling, by the individual, privileges which the predetermined agent has for accessing the confidential record.

8. The method of claim 2 further comprising the step of associating a class of agents with a set of privileges for accessing the confidential record, wherein the predetermined agent is a member of the class.

9. The method of claim 2 wherein the access token is a private cryptographic key.

10. The method of claim 2 wherein the access token is a biometric of the predetermined individual that is measurable by a biometric hardware device.

11. The method of claim 2 wherein the access token is a smart-card.

12. The method of claim 2 further comprising the step of accessing by the predetermined agent the encrypted confidential record on the record server from any node on the network capable of accepting the access token.

13. The method of claim 2 further comprising the step of maintaining anonymity of the individual when the predetermined agent accesses the encrypted confidential record of the individual.

14. The method of claim 2 further comprising the step of determining by the individual each portion of the confidential record that is accessible to the predetermined agent.

15. The method of claim 1 wherein the gateway system and the record server selected by the individual are the same node on the network.

16. The method of claim 1 further comprising the step of defining a schema for representing the confidential record using a markup language.

17. In a network, a system for providing access to confidential records of an individual comprising:
digital information representing a confidential record of the individual;
a publicly accessible server system connected to the network and selected by the individual for storing the confidential record; and
a gateway system, in communication with the server system, comprising software for accessing the confidential record of the individual.

18. The system of claim 17 further comprising an access token distributed to a predetermined agent by the individual for use by the gateway system in accessing the stored confidential record.

19. The system of claim 18 wherein the access token is a private cryptographic key.

20. The system of claim 18 wherein the access token is a biometric of the predetermined agent that is measurable by a biometric hardware device.

21-27 (Cancelled).
